(19) United States
(12) Patent Application Publication
(10) Pub. No.: US 2006/0064401 A1
(43) Pub. Date: Mar. 23, 2006

(54) Targeted Web Browser

(76) Inventor: John W. Duncan, Earlham, IA (US)

Correspondence Address: THE WOLF'S PAW, 235 NORTH CHESTNUT AVENUE, EARLHAM, IA, 50072, US

(21) Appl. No.: 10/711,530

(22) Filed: Sep. 23, 2004

(51) Int. Cl. G06F 17/30

(52) U.S. Cl. 707/3

(57) ABSTRACT

This is a web browser program similar to other web browsers except for one major difference: Users can access only selected (targeted) web sites. A user is required to log in to a central web site, which then returns to the browser a list of web sites that user may access. Any attempt to access a site not on the list fails. An online database that matches users to web sites is maintained through the use of a web browser by a person with administrator access.

This is a web browser program similar to other web browsers except for one major difference: Users can access only selected (targeted) web sites. A user is required to log in to a central web site, which then returns to the browser a list of web sites that user may access. Any attempt to access a site not on the list fails. An online database that matches users to web sites is maintained through the use of this browser by a person with administrator access. The sequence of activities in using the browser is as follows:

1. A system administrator is chosen by the organization that purchases the license to use the browser.
2. I, or representative of my company, then add the system administrator to the database.
3. The system administrator adds the people to whom then want to give access. For each person, they enter a list of sites they may visit.
4. The user runs the Targeted Browser, which requires a login. When they log in, the database is queried, and if the login and password they enter matches that in the database, the list of sites they may access is returned to the browser.
5. From that point forward, any attempt to access a site not on the list fails, yet an attempt to access those on the list succeeds. If, for example, the web site TheWolfsPaw.com is on the list, they may view its home page or any subordinate pages as long as TheWolfsPaw.com is part of the page name.
6. When the user is done, they click the Logoff button, and the login screen pops up, making the browser available to another user.

What is claimed is:

1. I claim that I have invented the concept of a web browser system that controls what sites to which the user may have access. There are many browsers available, most of which are free, and all of which allow the user to access virtually every one of the millions of web sites on the Internet. There is a need to keep certain people from accessing inappropriate web sites, for example, to make online educational programs available to prison inmates. However, prison administrators fear the inmates may abuse their privileges and visit inappropriate sites. All attempts to control web access have tried, unsuccessfully, to control the sites one cannot visit. Given the millions of existing web sites, this is doomed to failure. This system instead controls the sites one can visit. Allowing the visitation of a select set of sites is much easier and guarantees success. They may visit only the sites the system has for them in its database. An individualized list of sites each person may visit is stored in the online database, so it's easy to manage what they may visit. The organization's administrator may use any web browser to access the database to manage the organization's users via a secure connection to the Internet.
